(19) United States
(12) Patent Application Publication
(10) Pub. No.: US 2017/0077626 A1
(43) Pub. Date: Mar. 16, 2017

(54) BATTERY TERMINAL

(71) Applicant: Sumitomo Wiring Systems, Ltd., Yokkaichi, Mie (JP)

(72) Inventors: Ryosuke Yamada, Yokkaichi, Mie (JP); Takamaru Amano, Yokkaichi, Mie (JP); Yuichi Nakanishi, Yokkaichi, Mie (JP)

(21) Appl. No.: 15/122,983

(22) PCT Filed: Feb. 18, 2015
(86) PCT No.: PCT/JP2015/054362

§ 371 Date: Sep. 1, 2016

(30) Foreign Application Priority Data
Mar. 4, 2014 (JP) 2014-041492

(51) Int. Cl. H01R 11/28; H01M 2/30

(52) U.S. Cl. CPC H01R 11/283; H01M 2/305; H01M 2220/20

(57) ABSTRACT

A battery terminal (1) includes a main body (10) with an upper plate (20U) including an upper plate mounting hole (23U), a lower plate (20L) including a lower plate mounting hole (23L), and first and second couplings (30A, 30B) that couple the upper and lower plates (20U, 20L). A bracket (70) deforms the upper and lower plate mounting holes (23U, 23L) to reduce diameters by being mounted on the terminal main body (10). The first and second couplings (30A, 30B) have first and second contact surfaces (32A, 32B) perpendicular to the upper and lower plates (20U, 20L). A nut (90) is arranged between the upper and lower plates (20U, 20L) and threadedly receives a bolt (80). A side surface (93A) of the nut (90) perpendicular to surfaces where a nut hole (91) is open is in contact with the first and second contact surfaces (32A, 32B).

### BACKGROUND

1. Field of the Invention

The present invention relates to a battery terminal.

2. Description of the Related Art

A battery terminal is a member to be mounted on a battery post of a battery provided in a vehicle. A battery terminal manufactured by press-working one metal plate is disclosed in Publication of Japanese Patent No. 4033285.

The battery terminal disclosed in the Publication of Japanese Patent No. 4033285 includes a terminal main body, fastening portions and bolts and nuts for fastening the fastening portions to the terminal main body. The terminal main body is formed by bending one metal plate and includes an upper side portion and a lower side portion arranged in parallel to each other. The upper side portion includes an annular electrode fitting portion having a cut, and two fastening portions extending from opposite sides of the cut of this electrode fitting portion. The lower side portion similarly includes an electrode fitting portion and two fastening portions. The fastening portion includes an upper surface portion to be fastened and fixed to the upper side portion using the bolt and nut and two side portions extending from the upper surface portion. Each side portion has a plurality of tapered surfaces inclined more outwardly with distance from the upper surface portion.

When the upper side portion is fastened to the terminal main body using the bolts and the nuts after a battery post is inserted through the electrode fitting portion, the tapered surfaces respectively press side edges of the two fastening portions of the upper side portion. Components of these pressing forces in a direction parallel to the upper side portion move the two fastening portions in directions toward each other and the electrode fitting portion is deformed to have a smaller diameter. The lower side portion is fastened similarly. In this way, the inner peripheral surfaces of the electrode fitting portions come into contact with the outer peripheral surface of the battery post and the battery terminal and the battery post are connected electrically.

An example in which the nuts for fastening the fastening portions to the terminal main body are arranged between the upper side portion and the lower side portion is shown in the Publication of Japanese Patent No. 4033285. According to this configuration, there is an advantage of being able to reduce a height of the battery terminal by a thickness of the nuts. Further, since an interval between the upper side portion and the lower side portion is held by the presence of the nuts, there is an advantage of being able to suppress that the terminal main body is squeezed (to bring the upper side portion and lower side portion closer to each other) and deformed due to components of the pressing forces by the tapered surfaces in the direction perpendicular to the upper side portion.

However, in the above configuration, it is difficult to press the nut with a tool in tightening the bolt. Thus, the nut rotates according to the rotation of the bolt and it may not be possible to fix the fastening portion to the terminal main body with a sufficient fastening force. If such a situation occurs, the battery terminal and the battery post may not be connected sufficiently.

The present invention was completed based on the above situation and aims to provide a battery terminal capable of ensuring connection reliability with a battery post.

### SUMMARY

The present invention is directed to a battery terminal to be mounted on a battery post provided on a battery. The battery terminal includes a terminal main body with an upper plate, a lower plate parallel to the upper plate and a coupling that couples the upper and lower plates. The upper plate includes an upper plate mounting hole, and the battery post is inserted through the upper plate mounting hole. An upper plate slit extending from an edge of the upper plate mounting hole to an end edge of the upper plate. Parts arranged at opposite sides of the upper plate slit include first and second upper plate fastening portions. The lower plate includes a lower plate mounting hole, and the battery post being inserted through the lower plate mounting hole. A lower plate slit extends from an edge of the lower plate mounting hole to an end edge of the lower plate. Parts arranged at opposite sides of the lower plate slit include first and second lower plate fastening portions. A fastening member is mounted on the terminal main body and presses the first and second upper plate fastening portions and the first and second lower plate fastening portions in directions toward each other for deforming the upper plate mounting hole and the lower plate mounting hole to reduce diameters. A nut is arranged between the upper and lower plates and includes a nut hole. A bolt fixes the fastening member to the terminal main body by being screwed into the nut. The coupling has a contact surface perpendicular to the upper and lower plates. The nut has a plurality of side surfaces perpendicular to surfaces where the nut hole is opened, and one of the side surfaces is in contact with the contact surface with the fastening member fixed to the terminal main body.

According to the above configuration, by holding the one side surface of the nut in contact with the contact surface, the rotation of the nut can be suppressed even if the nut is arranged between the upper and lower plates (i.e. even if the nut is arranged in a narrow space where it is difficult to press the nut with a tool when screwing the bolt). In this way, it is possible to fix the fastening member to the terminal main body with a sufficient fastening force and ensure connection reliability between the battery terminal and the battery post.

The nut may be a square nut having four side surfaces. If the square nut is used, an area of the one side surface to be brought into contact with the contact surface is larger as compared to a hexagonal nut or the like closer to a cylindrical shape. Further, since angles between the one side surface and other side surfaces adjacent to the one side surface are small, a corner part between the one side surface and the other side surface is easily caught by the contact surface when the nut is going to rotate. As just described, the square nut is advantageous in suppressing rotation of the nut.

According to the present invention, it is possible to provide a battery terminal capable of ensuring connection reliability with a battery post.

### BRIEF DESCRIPTION OF THE DRAWINGS

FIG. 1 is a perspective view of a battery terminal of an embodiment.

FIG. 2 is an exploded perspective view of the battery terminal and a battery post of the embodiment.

FIG. 3 is a plan view of the battery terminal of the embodiment.

FIG. 4 is a bottom view of the battery terminal of the embodiment.

FIG. 5 is a front view of the battery terminal of the embodiment.

FIG. 6 is a rear view of the battery terminal of the embodiment.

FIG. 7 is a right side view of the battery terminal of the embodiment.

FIG. 8 is a left side view of the battery terminal of the embodiment.

FIG. 9 is a section along A-A of FIG. 3.

FIG. 10 is a section along B-B of FIG. 3.

FIG. 11 is a section along C-C of FIG. 7.

FIG. 12 is a perspective view showing a state where the battery terminal of the embodiment is mounted on the battery post.

FIG. 13 is a section cut at the same position as B-B of FIG. 3 showing the battery terminal of the embodiment mounted on the battery post.

FIG. 14 is a section cut at the same position as C-C of FIG. 7 showing the battery terminal of the embodiment mounted on the battery post.

### DETAILED DESCRIPTION

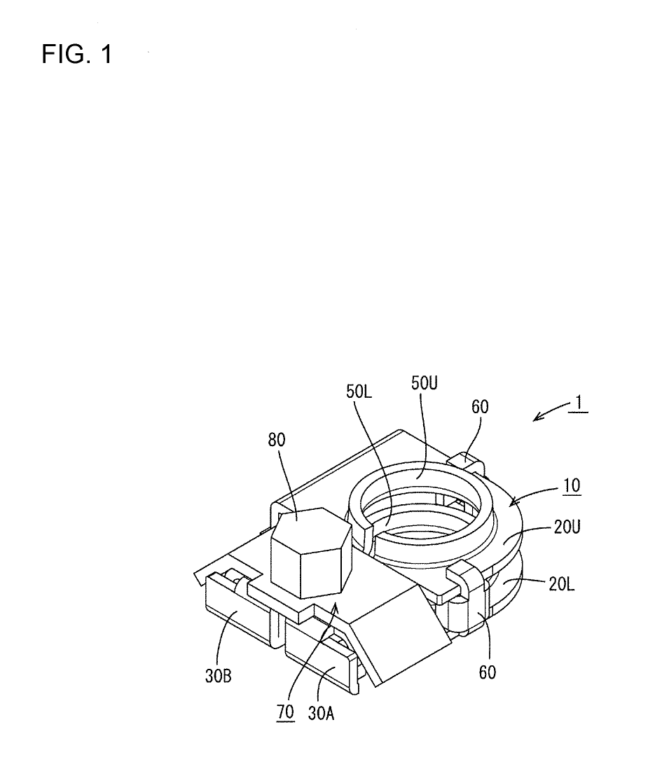

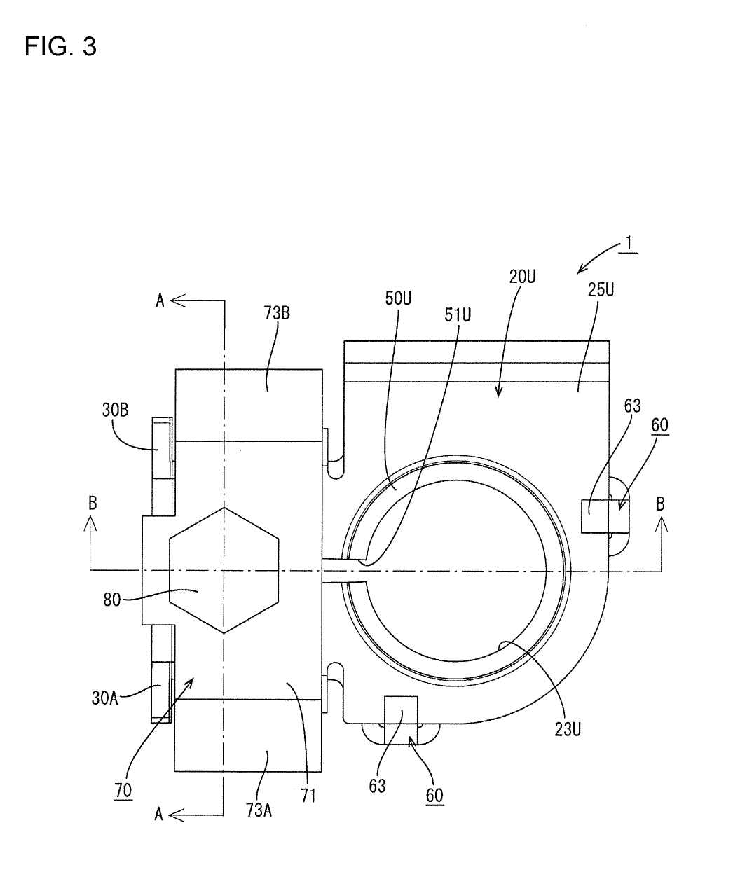

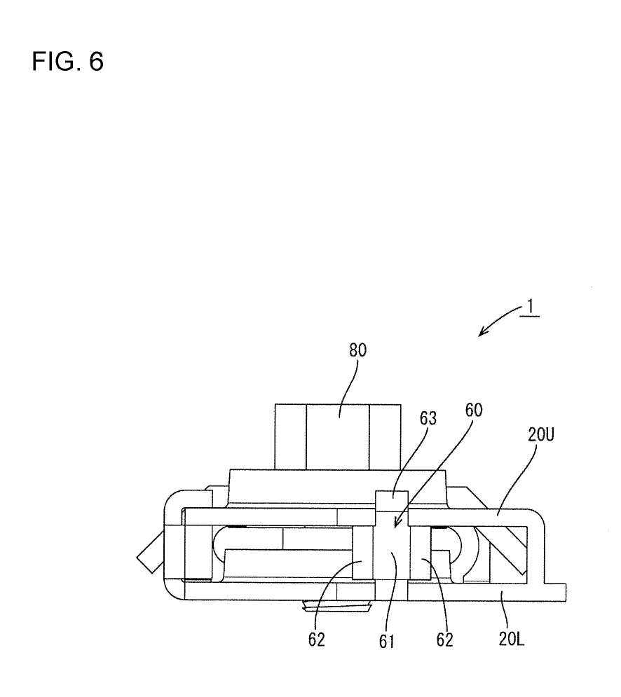

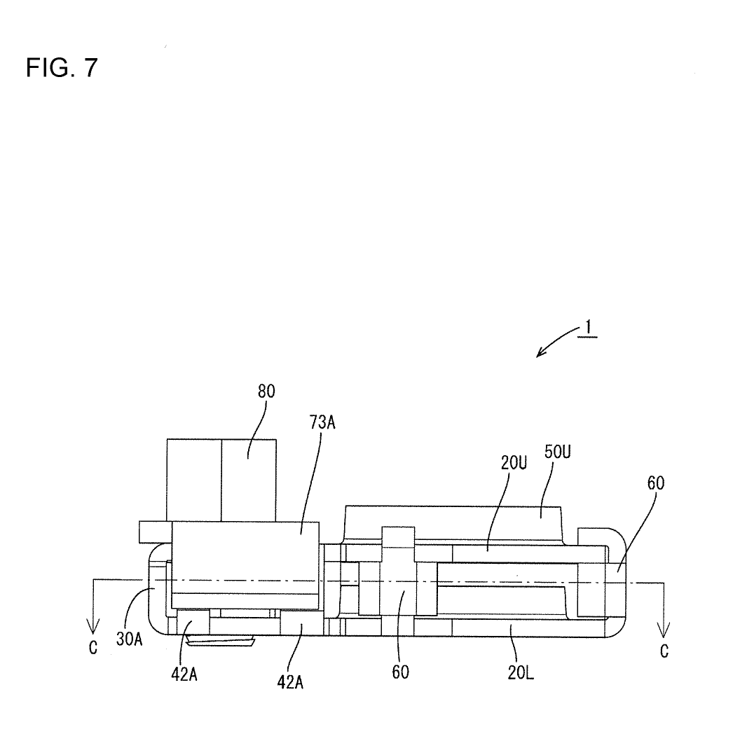

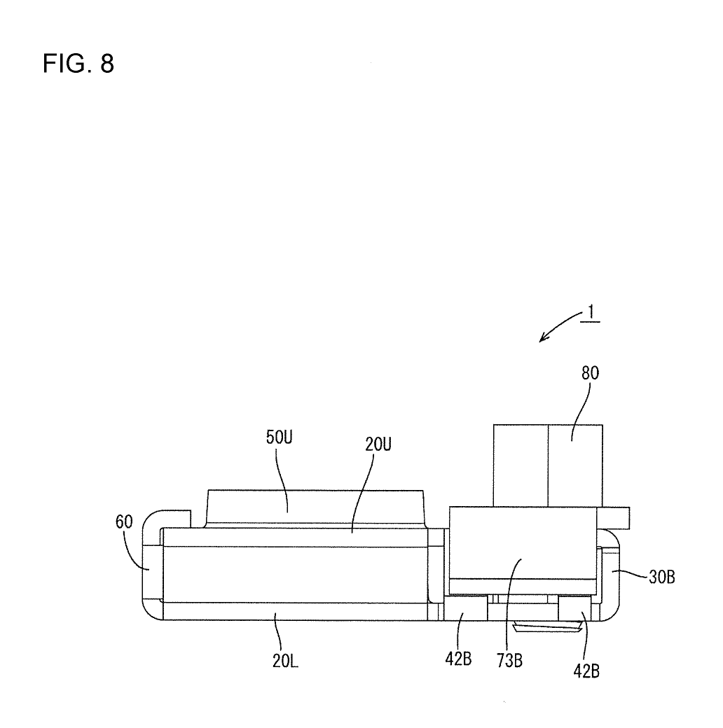

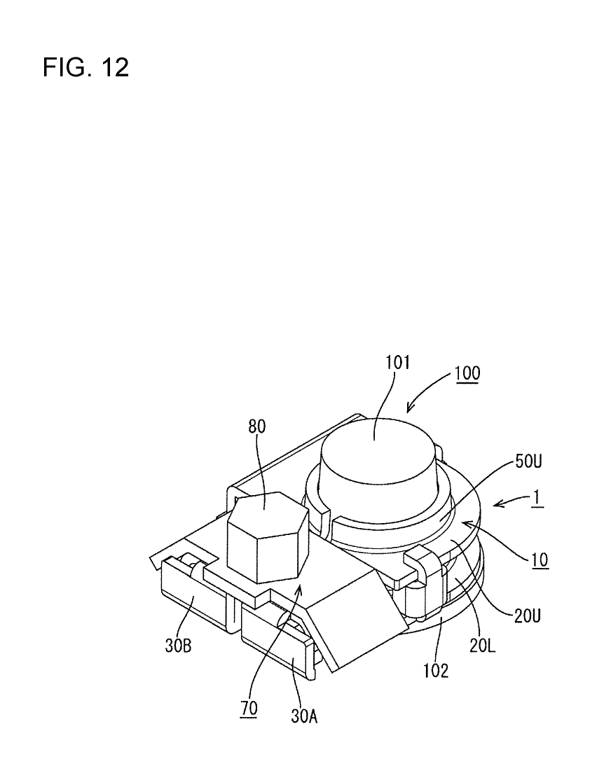

An embodiment of the present invention is described with reference to FIGS. 1 to 14. A battery terminal 1 of this embodiment is mounted on a battery post 100 provided on a battery (not shown) of a vehicle. The battery post 100 includes a cylindrical shaft 101 and a seat 102 arranged on one end of the shaft 101.

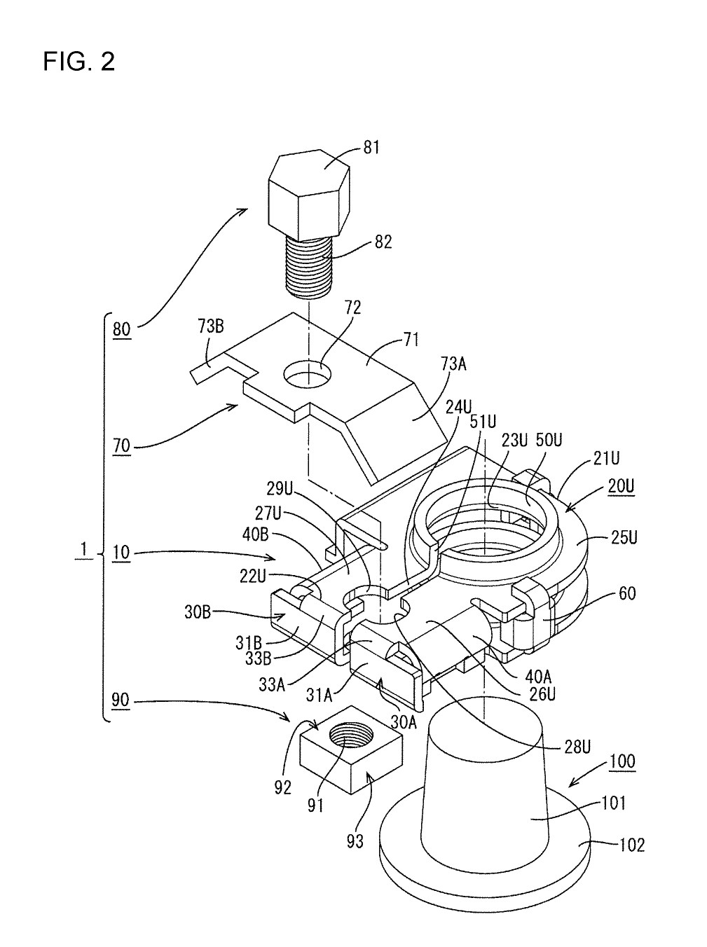

As shown in FIGS. 1 and 2, the battery terminal 1 includes a terminal main body 10, a bracket 70 (corresponding to a fastening member), a bolt 80 and a nut 90.

The terminal main body 10 includes an upper plate 20U, a lower plate 20L, first and second couplings 30A, 30B, first and second receiving portions 40A, 40B, upper and lower mounting tubes 50U, 50L and a plurality of stoppers 60.

As shown in FIG. 2, the upper plate 20U is a plate-like part long in one direction and has first and second short sides 21U, 22U perpendicular to a length direction. The upper plate 20U is arranged perpendicular to an axial direction of the shaft 101 of the battery post 100.

The upper plate 20U includes an upper plate mounting hole 23U and an upper plate slit 24U. The upper plate mounting hole 23U penetrates from one surface to the other surface of the upper plate 20U, and the shaft 101 is inserted. The upper plate mounting hole 23U is arranged proximate to the first short side 21U of the upper plate 20U. The upper plate mounting hole 23U has an inner diameter slightly larger than an outer diameter of the shaft 101 in a free state where the battery terminal 1 is not mounted on the battery post 100.

The upper plate slit 24U is a clearance extending from an edge of the upper plate mounting hole 23U to the second short side 22U (corresponding to an end edge), which is more distant from the upper plate mounting hole 23U along the length direction of the upper plate 20U. By the presence of this upper plate slit 24U, a part of the upper plate 20U between the upper plate mounting hole 23U and the second short side 22U is divided into two parts.

A part of the upper plate 20U surrounding the upper plate mounting hole 23U is an upper plate mounting portion 25U. One of the two parts arranged across the upper plate slit 24U is a first upper plate fastening portion 26U and the other is a second upper plate fastening portion 27U.

The first upper plate fastening portion 26U has a halved recess 28U. The halved recess 28U is recessed from an end surface of the first upper plate fastening portion 26U facing the second upper plate fastening portion 27U in a direction away from the second upper plate fastening portion 27U. The second upper plate fastening portion 27U also similarly has a halved recess 29U. The halved recess 29U is recessed from an end surface of the second upper plate fastening portion 27U facing the first upper plate fastening portion 26U in a direction away from the first upper plate fastening portion 26U. The two halved recesses 28U, 29U are arranged to face each other, and a space enclosed by the two halved recesses 28U, 29U serves as a space for the insertion of the bolt 80.

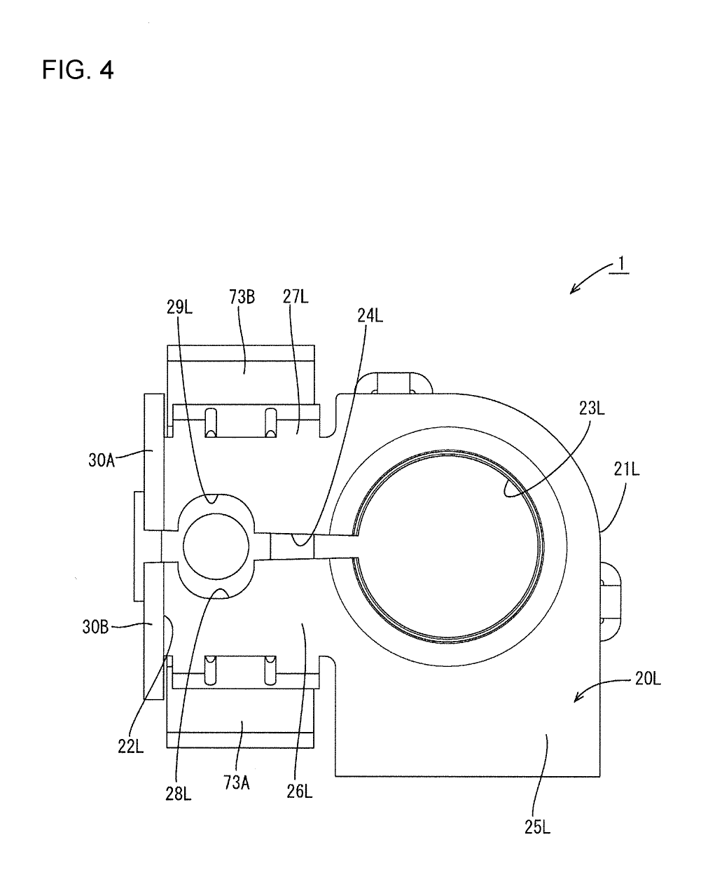

As shown in FIG. 4, the lower plate 20L has an outer shape similar to the upper plate portion 20U and has first and second short sides 21L, 22L perpendicular to a length direction. The lower plate 20L is arranged parallel to and at a distance from the upper plate 20U.

As shown in FIG. 4, the lower plate 20L includes a lower plate mounting hole 23L and a lower plate slit 24L. The lower plate mounting hole 23L is shaped similar to the upper plate mounting hole 23U and is arranged proximate to the first short side 21L of the lower plate 20L. The lower plate slit 24U is a clearance extending from an edge of the lower plate mounting hole 23L to the second short side 22L (corresponding to an end edge) more distant from the lower plate mounting hole 23L along the length direction of the lower plate 20L. By the presence of this lower plate slit 24L, a part of the lower plate 20L between the lower plate mounting hole 23L and the second short side 22L is divided into two parts.

Similar to the upper plate 20U, a part of the lower plate 20L surrounding the lower plate mounting hole 23L is a lower plate mounting portion 25L. Further, out of the two parts arranged across the lower plate slit 24L, the part arranged on the same side as the first upper plate fastening portion 26U is a first lower plate fastening portion 26L and the part arranged on the same side as the second upper plate fastening portion 27U is a second lower plate fastening portion 27L. The first and second lower plate fastening portions 26L, 27L respectively have halved recesses 28L, 29L similarly to the first and second upper plate fastening portions 26U, 27U, and a space enclosed by the two halved recesses 28L, 29L serves as a space for the insertion of the bolt 80.

When viewed in a direction perpendicular to plate surfaces of the upper plate 20U and the lower plate 20L, the upper plate mounting hole 23U and the lower plate mounting hole 23L are arranged to overlap each other, the upper plate slit 24U and the lower plate slit 24L are arranged to overlap each other and the halved recesses 28U, 29U of the upper plate 20U and the halved recesses 28L, 29L of the lower plate 20L are arranged to overlap each other.

The first coupling 30A couples an end edge of the first upper plate fastening portion 26U on a side opposite to the upper plate mounting portion 25U and an end edge of the first lower plate fastening portion 26L on a side opposite to the lower plate mounting portion 25L. The second coupling 30B couples an end edge of the second upper plate fastening portion 27U on a side opposite to the upper plate mounting portion 25U and an end edge of the second lower plate fastening portion 27L on a side opposite to the lower plate mounting portion 25L.

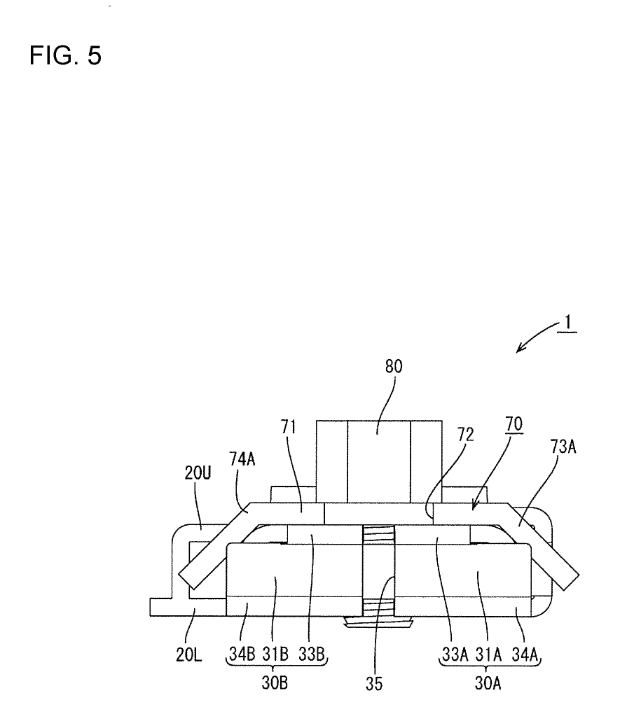

As shown in FIG. 5, the first coupling 30A includes a first flat plate portion 31A and first and second hinges 33A, 34A.

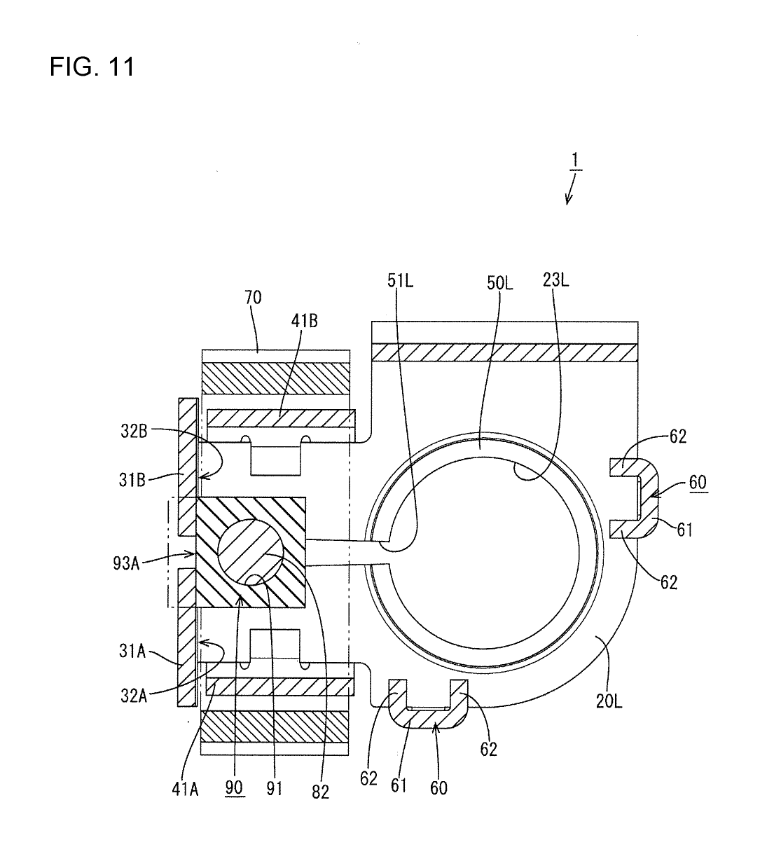

The first flat plate 31A is a flat plate-like part arranged perpendicular to the first upper plate fastening portion 26U and the first lower plate fastening portion 26L. An inner side surface (surface facing the first upper plate fastening portion 26U and the first lower plate fastening portion 26L) of the first flat plate 31A is a first contact surface 32A perpendicular to plate surfaces of the first upper plate fastening portion 26U and the first lower plate fastening portion 26L (see also FIG. 11). One end of the first flat plate 31A is located more outward (toward a side away from the upper plate slit 24U and the lower plate slit 24L) than outer end edges (end edges on a side opposite to the upper plate slit 24U and the lower plate slit 24L) of the first upper plate fastening portion 26U and the first lower plate fastening portion 26L.

The first hinge 33A is arranged between and couples the first upper plate fastening portion 26U and the first flat plate portion 31A. The second hinge 34A is arranged between and couples the first lower plate fastening portion 26L and the first flat plate portion 31A.

The second coupling 30B includes a second flat plate 31B and first and second hinges 33B, 34B.

The second flat plate 31B is a plate-like part arranged perpendicular to the second upper plate fastening portion 27U and the second lower plate fastening portion 27L. An inner side surface (surface facing the second upper plate fastening portion 27U and the second lower plate fastening portion 27L) of the second flat plate 31B is a second contact surface 32B perpendicular to plate surfaces of the second upper plate fastening portion 27U and the second lower plate fastening portion 27L. Further, one end of the second flat plate 31B is located more outward (toward a side away from the upper plate slit 24U and the lower plate slit 24L) than outer end edges (end edges on a side opposite to the upper plate slit 24U and the lower plate slit 24L) of the second upper plate fastening portion 27U and the second lower plate fastening portion 27L.

The first hinge 33B is arranged between and couples the second upper plate fastening portion 27U and the second flat plate portion 31B. The second hinge 34B is arranged between and couples the second lower plate fastening portion 27L and the second flat plate portion 31B.

There is a clearance between the first and second couplings 30A, 30B. This clearance serves as a coupling slit 35 communicating with the upper plate slit 24U and the lower plate slit 24L.

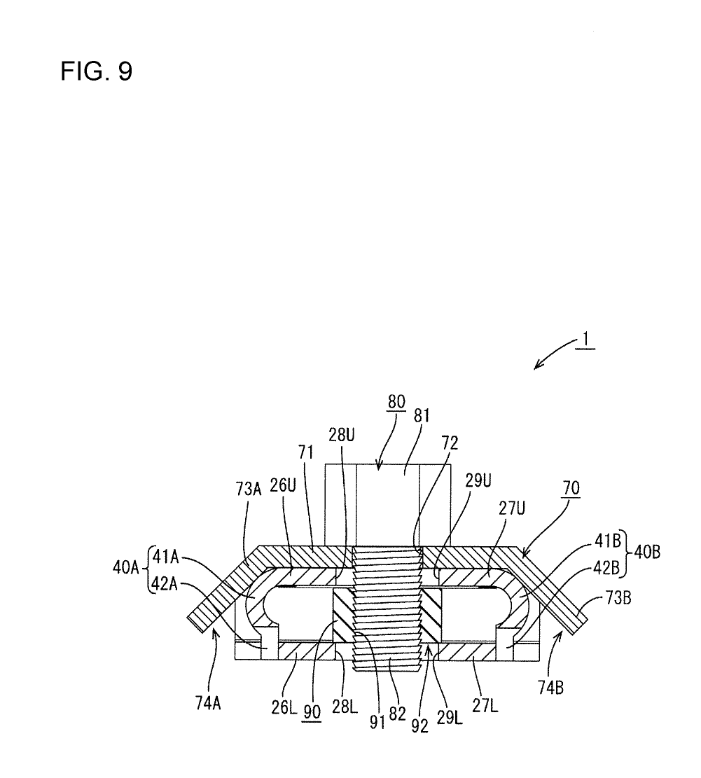

As shown in FIG. 9, the first receiving portion 40A includes a first receiving wall 41A and a first engaging portion 42A. The first receiving wall 41A is a plate-like part extending from an outer side edge of the first upper plate fastening portion 26U toward the first lower plate fastening portion 26L and has an arcuate cross-section bulging outwardly (direction away from the upper plate slit 24U and the lower plate slit 24L). The first engaging portion 42A is arranged on an end edge of the first receiving portion 41A and is to be engaged with the first lower plate fastening portion 26L.

The second receiving portion 40B includes a second receiving wall 41B and a second engaging portion 42B. The second receiving wall 41B is a plate-like part extending from an outer side edge of the second upper plate fastening portion 27U toward the second lower plate fastening portion 27L and has an arcuate cross-section bulging outwardly (direction away from the upper plate slit 24U and the lower plate slit 24L). The second engaging portion 42B is arranged on an end edge of the second receiving portion 41B and is to be engaged with the second lower plate fastening portion 27L.

As shown in FIGS. 2, 3 and 10, the upper plate mounting tube 50U is a tubular part extending from an edge of the upper plate mounting hole 23U in a direction perpendicular to the upper plate 20U and away from the lower plate 20L. The upper plate mounting tube 50U includes an upper tube slit 51U. The upper tube slit 51U is a clearance communicating with the upper plate slit 24U and extending to an end edge of the upper plate mounting tube 50U on a side opposite to the upper plate 20U. By the presence of this upper tube slit 51U, the upper plate mounting tube 50U is a tube including a cut and having a C-shaped cross-section.

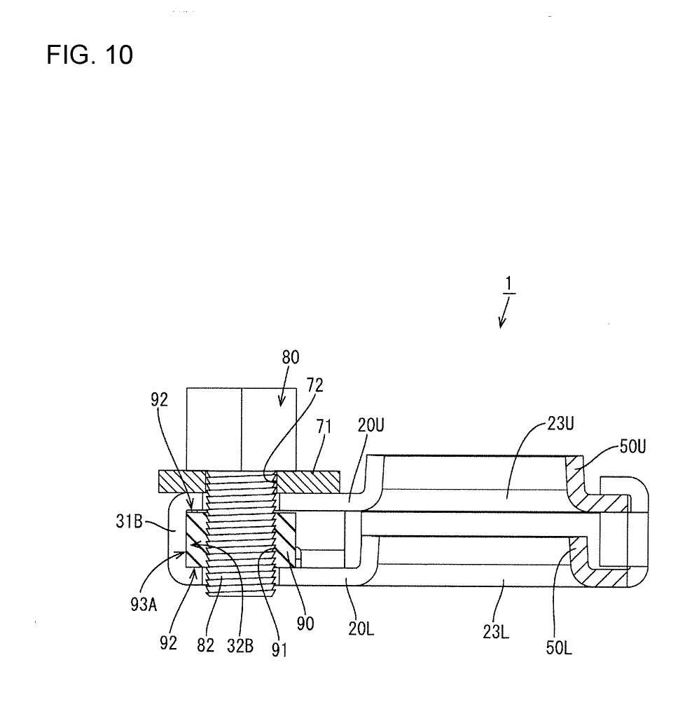

As shown in FIGS. 10 and 11, the lower plate mounting tube 50L is a tubular part extending from an edge of the lower plate mounting hole 23L in a direction perpendicular to the lower plate 20L and toward the upper plate 20U. The lower plate mounting tube 50L includes a lower tube slit 51L. The lower tube slit 51L is a clearance communicating with the lower plate slit 24L and extending to an end edge of the lower plate mounting tube 50L on a side opposite to the lower plate 20L. By the presence of this lower tube slit 51L, the lower plate mounting tube 50L is a tube including a cut and having a C-shaped cross-section.

The stoppers 60 are parts for holding the upper plate mounting 25U and the lower plate mounting 25L while maintaining a predetermined interval. As shown in FIGS. 2, 3, 6 and 11, each stopper 60 includes a main piece 61 extending from an end edge of the lower plate mounting portion 25L toward the upper plate mounting portion 25U, holding pieces 62 connected to the main piece 61 and sandwiched between the upper plate mounting portion 25U and the lower plate mounting portion 25L and a locking piece 63 connected to the main piece 61 and extending along a plate surface of the upper plate mounting portion 25U on a side opposite to the lower plate mounting portion 25L.

The bracket 70 is to be mounted on the terminal main body 10 by the bolt 80 and the nut 90 for deforming the terminal main body 10 to reduce diameters of the upper plate mounting hole 23U and the lower plate mounting hole 23L. As shown in FIG. 2, the bracket 70 includes a base 71 and first and second pressing portions 73A, 73B.

The base 71 is a rectangular plate and a part to be placed on surfaces of the first upper plate fastening portion 26U and the second upper plate fastening portion 27U on a side opposite to the lower plate 20L. A distance between two sides of the base 71 parallel to the upper plate slit 24U is shorter than a distance between the outer end edge of the first upper plate fastening portion 26U and that of the second upper plate fastening portion 27U. The base 71 includes a bolt insertion hole 72 penetrating from a surface facing the upper plate 20U to an opposite surface thereof.

The first pressing portion 73A is a plate-like part extending toward the terminal main body 10 from the side of the base 71 that is closer to the first upper plate fastening portion 26U and that is parallel to the upper plate slit 24U. The second pressing portion 73B is a plate-like part extending toward the terminal main body 10 from the side of the base 71 that is closer to the second upper plate fastening portion 27U and that is parallel to the upper plate slit 24U.

The first and second pressing portions 73A, 73B are respectively inclined in directions to be more separated from each other with distance from the base 71. As shown in FIG. 9, surfaces of the first and second pressing portions 73A, 73B facing each other are respectively a first tapered surface 74A and a second tapered surface 74B inclined in directions to be more separated from each other with distance from the base 71. The first and second pressing portions 73A, 73B respectively press the first and second receiving walls 41A, 41B toward each other by bringing the first and second tapered surfaces 74A, 74B into contact with the first and second receiving walls 41A, 41B.

The bolt 80 has a general shape including a head 81 and a trunk 82 having an external thread on an outer peripheral surface.

The nut 90 is a square nut in the form of a rectangular block and has a nut hole 91. As shown in FIG. 2, the nut hole 91 penetrates from one surface to the opposite surface of the nut 90 and has a thread groove on an inner peripheral surface. The nut 90 is arranged between the first and second upper plate fastening portions 26U, 27U and the first and second lower plate fastening portions 26L, 27L.

The nut 90 has two opening surfaces 92 where the nut hole 91 is open and four side surfaces 93 different from these two surfaces. The nut 90 is arranged so that the two opening surfaces face the upper plate 20U and the lower plate 20L. When viewed in the direction perpendicular to plate surfaces of the upper plate 20U and the lower plate 20L, the nut hole 91, a space enclosed by the two halved recesses 28U, 29U of the upper plate 20U and a space enclosed by the two halved recesses 28L, 29L of the lower plate 20L are arranged to overlap each other. The four side surfaces 93 are perpendicular to the opening surfaces 92.

The trunk 82 of the bolt 80 is inserted into the bolt insertion hole 72 and the space closed by the two halved recesses 28U, 29U of the upper plate 20U and screwed into the nut 90 so that the bracket 70 is fixed to the terminal main body 10. As shown in FIGS. 10 and 11, one side surface 93A out of the four side surfaces 93 of the nut 90 is arranged in contact with the first and second contact surfaces 32A, 32B with the bracket 70 fixed to the terminal main body 10 by the bolt 80 and the nut 90.

Next, the procedure of mounting the battery terminal 1 configured as described above on the battery post 100 is described.

The shaft 101 of the battery post 100 is inserted into the upper plate mounting hole 23U and the lower plate mounting hole 23L of the terminal main body 10. Further, the nut 90 is set between the first and second upper plate fastening portions 26U, 27U and the first and second lower plate fastening portions 26L, 27L. Subsequently, the bracket 70 is placed on the terminal main body 10. In a state where the bracket 70 is not screwed to the terminal main body 10, the first and second pressing portions 73A, 73B respectively contact the first and second receiving walls 41A, 41B and the base 71 is lifted slightly from the first and second upper plate fastening portions 26U, 27U.

In this state, the bolt 80 is inserted into the bolt insertion hole 72 and screwed into the nut 90. At this time, the bolt 80 is tightened while the one side surface 93A of the nut 90 is brought into contact with the first and second contact surfaces 32A, 32B. In this way, the rotation of the nut 90 according to the rotation of the bolt 80 can be suppressed.

As the bolt 80 is tightened into the nut 90, the base 71 is pressed by the head 81 of the bolt 80 to move toward the first and second upper plate fastening portions 26U, 27U. Then, the first and second receiving walls 41A, 41B move in directions toward the base 71 (i.e. directions to narrow the interval between the first and second pressing portions 73A, 73B) while sliding in contact with the first pressing portion 73A and the first pressing portion 73B. In this way, the first and second receiving walls 41A, 41B move in directions toward each other.

A component of a pressing force of the first pressing portion 73A applied to the first receiving wall 41A in a direction parallel to the upper plate 20U and the lower plate 20L is transferred to the first upper plate fastening portion 26U and the first lower plate fastening portion 26L so that both move in directions toward the second upper plate fastening portion 27U and the second lower plate fastening portion 27L. Similarly, the second upper plate fastening portion 27U and the second lower plate fastening portion 27L also move in directions toward the first upper plate fastening portion 26U and the first lower plate fastening portion 26L.

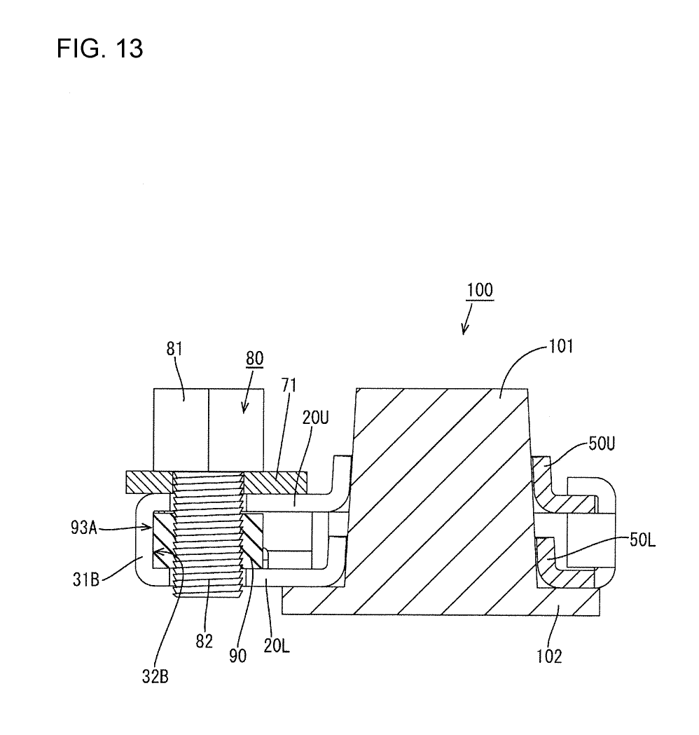

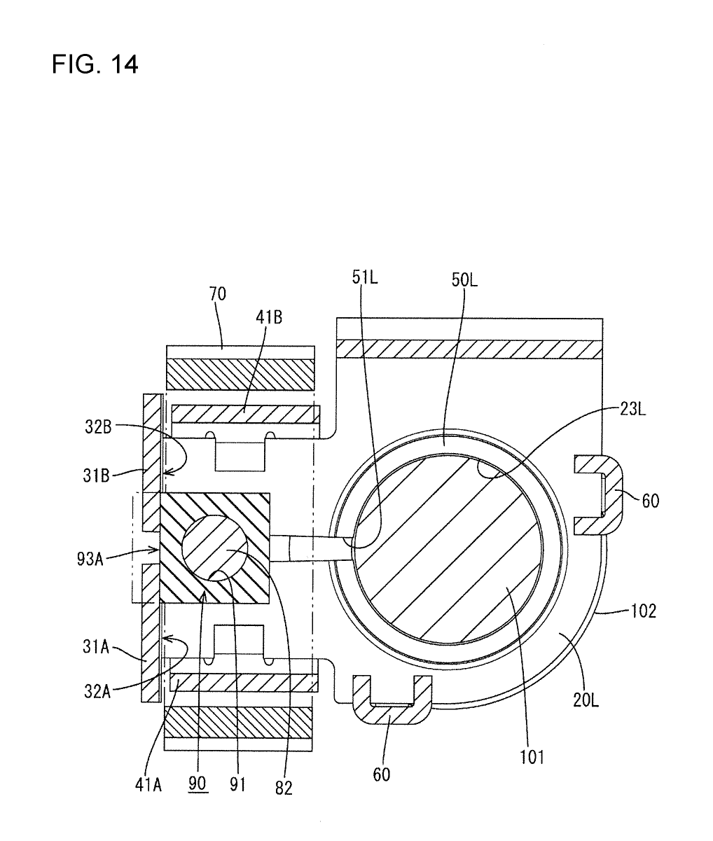

In this way, the diameters of the upper plate mounting hole 23U and the lower plate mounting hole 23L are reduced and the inner peripheral surfaces of the upper plate mounting hole 23U, the lower plate mounting hole 23L, the upper plate mounting tube portion 50U and the lower plate mounting tube portion 50L are held in close contact with the outer peripheral surface of the shaft 101 of the battery post 100 as shown in FIGS. 13 and 14. In this way, the battery terminal 100 and the battery terminal 1 are connected electrically conductively.

Here, since the nut 90 for fastening the bracket 70 to the terminal main body 10 is arranged between the first and second upper plate fastening portions 26U, 27U and the first and second lower plate fastening portions 26L, 27L, a height of the battery terminal 1 can be reduced by a thickness of the nut 90.

Further, the interval between the first and second upper plate fastening portions 26U, 27U and the first and second lower plate fastening portions 26L, 27L is held by the presence of the nut 90. In this way, it can be suppressed that the terminal main body 10 is squeezed and deformed by components of the pressing forces by the first and second pressing portions 73A, 73B in a direction perpendicular to the upper plate portion 20U and the lower plate portion 20L.

Further, since the nut is arranged in a narrow space, i.e. a space between the first and second upper plate fastening portions 26U, 27U and the first and second lower plate fastening portions 26L, 27L, it is difficult to press the nut 90 with a tool during a tightening operation of the bolt 80. However, the rotation of the nut 90 can be suppressed by holding the one side surface 93A of the nut 90 in contact with the first and second contact surfaces 32A, 32B when the bolt 80 is tightened. In this way, it is possible to fix the bracket 70 to the terminal main body 10 with a sufficient fastening force and ensure connection reliability between the battery terminal 1 and the battery post 100.

Further, the square nut is used as the nut 90. Thus, a large area of the one side surface 93A to be brought into contact with the first and second contact surfaces 32A, 32B can be ensured as compared to a hexagonal nut or the like closer to a cylindrical shape. Further, since angles between the one side surface 93A and other side surfaces 93 adjacent to the one side surface 93A are small, a corner part between the one side surface 93A and the other side surface 93 is easily caught by the first and second contact surfaces 32A, 32B when the nut 90 is going to rotate. Hence, the use of the square nut as the nut 90 is advantageous in suppressing the rotation of the nut 90.

The invention is not limited to the above described and illustrated embodiment. For example, the following embodiments are also included in the technical scope of the present invention.

Although the square nut is used as the nut 90 in the above embodiment, a rotation suppressing effect can be obtained if a polygonal nut having a side surface to be brought into contact with a contact surface is used and, for example, a hexagonal nut may be used.

Only a partial area of the inner side surface of the first flat plate 31A may be perpendicular to the plate surfaces of the first upper plate fastening portion 26U and the first lower plate fastening portion 26L and this perpendicular area may be a contact surface to be brought into contact with the nut 90. The same applies also to the second flat plate 31B.

### LIST OF REFERENCE SIGNS

1 . . . battery terminal
10 . . . terminal main body
20U . . . upper plate portion
22U . . . short side (end edge)
23U . . . upper plate mounting hole
24U . . . upper plate slit
26U . . . first upper plate fastening portion
27U . . . second upper plate fastening portion
20L . . . lower plate portion
22L . . . short side (end edge)
23L . . . lower plate mounting hole
24L . . . lower plate slit
26L . . . first lower plate fastening portion
27L . . . second lower plate fastening portion
30A . . . first coupling portion (coupling portion)
30B . . . second coupling portion (coupling portion)
32A . . . first contact surface (contact surface)
32B . . . second contact surface (contact surface)
70 . . . bracket (fastening member)
80 . . . bolt
90 . . . nut
91 . . . nut hole
93 . . . side surface
93A . . . one side surface
100 . . . battery post

1. A battery terminal to be mounted on a battery post provided on a battery, comprising:
a terminal main body including an upper plate, a lower plate arranged in parallel to the upper plate and a coupling that couples the upper and lower plates, the upper plate including an upper plate mounting hole, the battery post being inserted through the upper plate mounting hole, and an upper plate slit extending from an edge of the upper plate mounting hole to an end edge of the upper plate, parts arranged at opposite sides of the upper plate slit being a first upper plate fastening portion and a second upper plate fastening portion, the lower plate including a lower plate mounting hole, the battery post being inserted through the lower plate mounting hole, and a lower plate slit extending from an edge of the lower plate mounting hole to an end edge of the lower plate portion, parts arranged at opposite sides of the lower plate slit being a first lower plate fastening portion and a second lower plate fastening portion;
a fastening member for deforming the upper plate mounting hole and the lower plate mounting hole to reduce diameters by being mounted on the terminal main body and pressing the first and second upper plate fastening portions and the first and second lower plate fastening portions in directions toward each other;
a nut arranged between the upper and lower plates and including a nut hole; and
a bolt for fixing the fastening member to the terminal main body by being screwed into the nut;
wherein:
the coupling has a contact surface perpendicular to the upper and lower plates;
the nut has a plurality of side surfaces perpendicular to surfaces where the nut hole is opened; and
one of the side surfaces is in contact with the contact surface with the fastening member fixed to the terminal main body.

2. The battery terminal of claim 1, wherein the nut is a square nut having four side surfaces.
